(19) United States
(12) Patent Application Publication
(10) Pub. No.: US 2006/0038471 A1
(43) Pub. Date: Feb. 23, 2006

(54) Electric incandescent lamp for vehicle headlights

(75) Inventors: Manfred Buhler, Herbrechtingen (DE); Klaus Wittmann, Sontheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/197,361

(22) Filed: Aug. 5, 2005

(30) Foreign Application Priority Data
Aug. 19, 2004 (DE) 10 2004040417.8

(51) Int. Cl. H01K 1/14; H01K 1/50

(52) U.S. Cl. 313/271; 313/579

(57) ABSTRACT

The invention relates to an electric incandescent lamp, in particular a vehicle headlight lamp, having at least one frustoconical incandescent filament (2) which is arranged inside a transparent lamp vessel (10) and whose outside diameter increases continuously, starting from a minimum value at a first incandescent filament end (23), up to a maximum value at the second incandescent filament end (24), the following condition being fulfilled:

$$\frac{D2 - D1}{2 \cdot L} \leq 0.0875$$

for the minimum value D1 and the maximum value D2 as well as for the length L of the at least one incandescent filament (2).

### I. TECHNICAL FIELD

The invention relates to an electric incandescent lamp having at least one incandescent filament which is arranged inside a transparent lamp vessel and whose outside diameter increases continuously, starting from a minimum value at a first incandescent filament end, up to a maximum value at the second incandescent filament end.

### II. BACKGROUND ART

Such an incandescent lamp is disclosed, for example, in patent specification U.S. Pat. No. 5,508,587. This specification describes a halogen incandescent lamp having a base at one end, serving to couple light into a light guide, and having a lamp vessel, whose end remote from the base is designed as an optical lens, and an incandescent filament that is arranged inside the lamp vessel and whose outer contour has as envelope the lateral surface of a conical frustum.

### III. DISCLOSURE OF THE INVENTION

It is the object of the invention to provide an electric incandescent lamp that can be used in a vehicle headlight for producing the passing beam and, by contrast with conventional headlight lamps, ensures an increased luminance for imaging in the headlight in the area of the light/dark boundary.

This object is achieved according to the invention by an electric incandescent lamp having at least one incandescent filament which is arranged inside a transparent lamp vessel and whose outside diameter increases continuously, starting from a minimum value at a first incandescent filament end, up to a maximum value at the second incandescent filament end, wherein the following condition is fulfilled:

$$\frac{D2 - D1}{2 \cdot L} \leq 0.0875$$

for the minimum value D1 and the maximum value D2 as well as for the length L of the at least one incandescent filament.

Particularly advantageous designs of the invention are described in the dependent patent claims.

The electric incandescent lamp according to the invention has at least one incandescent filament which is arranged inside a transparent lamp vessel and whose outside diameter increases continuously, starting from a minimum value at a first incandescent filament end, up to a maximum value at the second incandescent filament end, the following condition

$$\frac{D2 - D1}{2 \cdot L} \leq 0.0875$$

being fulfilled according to the invention by the minimum value D1, the maximum value D2 and the length L of the at least one incandescent filament.

Because of the smaller outside diameter at the first incandescent filament end, the at least one incandescent filament has a higher luminance at this end. Moreover, because of its smaller outside diameter this incandescent filament end corresponds, however, to the ideal concept of a point light source. Consequently, the incandescent lamp according to the invention is particularly well suited for projection applications, for example as a light source in a vehicle headlight. In the case of this application, the light emitted by the first incandescent filament end can advantageously be used to produce a sharp light/dark boundary of the passing light by being projected into the far field in front of the headlight, and by the fact that the light emitted by the second incandescent filament end is projected into the near field of the headlight, directly in front of the vehicle. Consequently, a high luminance can be achieved in the area of the light/dark boundary of the passing light, where good illumination is desired. However, owing to the reduction in the outside diameter at the first incandescent filament end the at least one incandescent filament is heated up more strongly in this area. In order to avoid overheating of the at least one incandescent filament and a shortening of its service life, the conicity of the at least one incandescent filament of the incandescent lamp according to the invention is limited to a maximum value of 0.0875 in accordance with the above inequation. That is to say, the outsides or outside diameters of the turns of the at least one incandescent filament are arranged on the lateral surface of a circular cone whose opening angle at the vertex is at most approximately 10 degrees.

The incandescent lamp according to the invention is advantageously designed as an incandescent lamp with a base at one end, that is to say one end of its lamp vessel is provided with a base, the first incandescent filament end of the at least one incandescent filament facing the end of the lamp vessel that is provided with the base. In vehicle headlights, it is customary to use lamps having a base at one end that are mounted in the headlight reflector via a rear aperture such that the base is fixed in a holder of the rear aperture. Because of this orientation of the lamp, the light generated by the end of the incandescent lamp near the base is projected into the area of the light/dark boundary or the far field of the headlight. The end of the incandescent filament near the base is therefore preferably formed from the first incandescent filament end with the smaller outside diameter in order to achieve the abovenamed advantages. In accordance with the preferred exemplary embodiments of the invention, the at least one incandescent filament is aligned axially, that is to say the filament axis of the at least one incandescent filament extends parallel to the longitudinal extent of the lamp vessel or of the incandescent lamp and, in the case of an axially symmetrical lamp vessel, parallel to the longitudinal axis, or even lies on the longitudinal axis of the lamp vessel.

The length L of the at least one incandescent filament of the incandescent lamp according to the invention is preferably in a value range from 4.0 millimeters to 6.5 millimeters, in order to be able to use the incandescent lamp as a light source in a vehicle headlight. For reasons of production engineering, the pitch of the at least one incandescent filament of the incandescent lamp according to the invention is preferably smaller than 1.9 and greater than 1.3. Given a pitch of 1.9 and above, there would be the risk that the incandescent filaments could stick mechanically in the incandescent filament feed device and no longer be disentangled. Given pitches of 1.3 and smaller, electric short circuits would occur between neighboring turns of the incandescent filament.

### IV. BRIEF DESCRIPTION OF THE DRAWINGS

The invention is explained below in more detail with the aid of a number of preferred exemplary embodiments. In the drawing:

FIG. 1 shows a schematic side view of an incandescent filament in accordance with the preferred exemplary embodiments of the invention,

FIG. 2 shows a schematic side view of a vehicle headlight lamp in accordance with the first exemplary embodiment of the invention, and

FIG. 3 shows a schematic side view of a vehicle headlight lamp in accordance with the second exemplary embodiment of the invention.

### V. BEST MODE FOR CARRYING OUT THE INVENTION

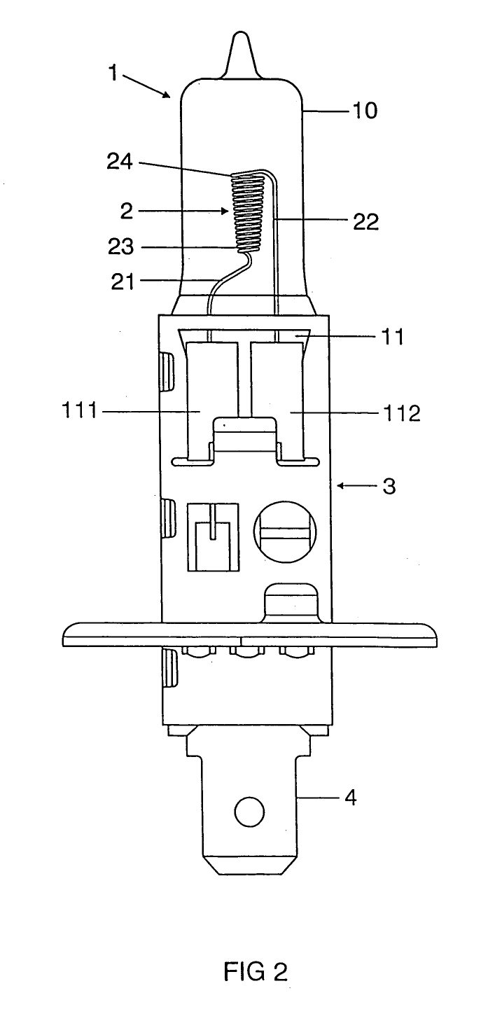

FIG. 2 is a schematic of a halogen incandescent lamp for a vehicle headlight in accordance with the first exemplary embodiment of the invention. This halogen incandescent lamp 1 has an electric power consumption of 55 watts and a nominal voltage of 12 volts, and serves to produce the passing light in a motor vehicle headlight. The halogen incandescent lamp 1 has a lamp vessel 10 made from quartz glass with a sealed end 11 that is provided with a metallic base 3. An incandescent filament 2 made from a single-coiled tungsten wire 200 is arranged inside the lamp vessel 10. The incandescent filament 2 is aligned axially inside the lamp vessel 10, that is to say parallel to the longitudinal axis of the lamp vessel 10, or lies on the longitudinal axis of the lamp vessel 10. The two uncoiled outgoing filament sections 21, 22 of the incandescent filament 2 are respectively connected via a molybdenum foil 111, 112 embedded in a gastight manner in the sealed end 11 of the lamp vessel 10 to a current supply wire that projects from the lamp vessel 10 and is electrically conductively connected to the contact lug 4 or to the base shell 3.

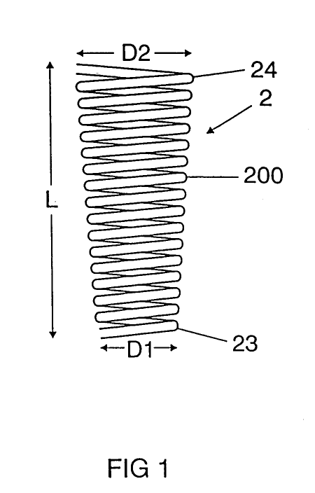

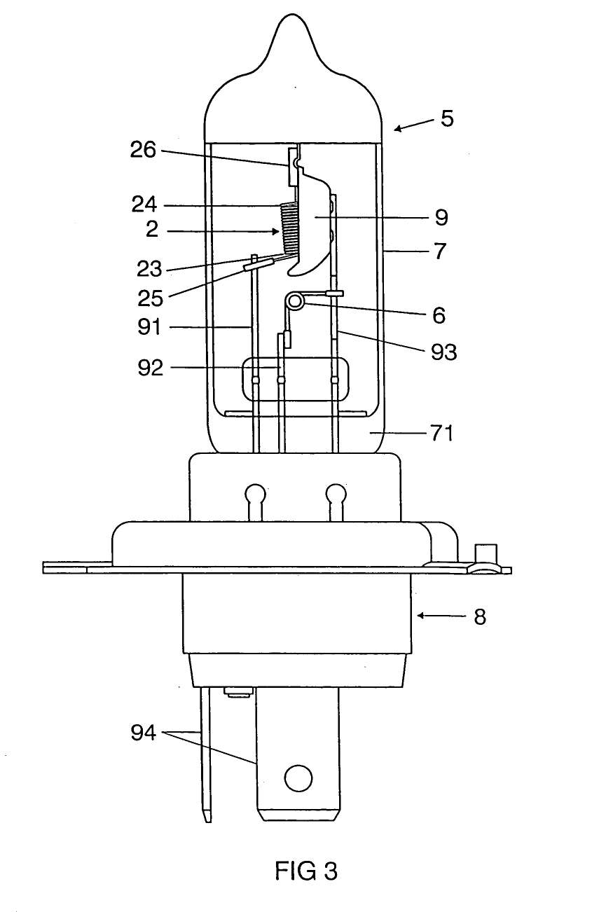

FIG. 1 illustrates schematically details of the incandescent filament 2 that is used to produce the passing light in the case of the halogen incandescent lamps illustrated in FIGS. 1 and 3. The incandescent filament 2 has an outer contour that substantially corresponds to the lateral surface of a conical frustum. The outside diameter of the turns of the incandescent filament 2 increases continuously starting from a minimum value D1 in the case of the first turn at the first incandescent filament end 23, up to a maximum value D2 in the case of the last turn at the second incandescent filament end 24. In accordance with a preferred exemplary embodiment of the invention, the incandescent filament 2 has a length L of 4.33 millimeters, an outside diameter D1 of 0.48 millimeters for the first turn, and an outside diameter D2 of 1.24 millimeters for the last, sixteenth turn. The thickness of the filament wire 200 is 155.2 micrometers. The pitch of this incandescent filament is 1.8. In the case of the lamps in accordance with FIGS. 2 and 3, the first incandescent filament end 23 with the reduced outside diameter D1 faces the base 3 or 8, respectively. FIG. 3 is a schematic of a halogen incandescent lamp for a vehicle headlight in accordance with the second exemplary embodiment of the invention. This halogen incandescent lamp is a two-filament halogen incandescent lamp 5 with two incandescent filaments 2, 6 that serve to produce the passing light and the upper beam of the vehicle. This halogen incandescent lamp 5 is provided for operating on a nominal vehicle network voltage of 12 volts. It has a lamp vessel 7 made from hard glass, for example from aluminum silicate glass, with a sealed end 71 that is provided with a metallic base 8. A first incandescent filament 6 for producing the upper beam, and a second incandescent filament 2 for producing the passing beam of the vehicle are arranged inside the lamp vessel 7. The incandescent filament 2 has the above-described properties and is therefore provided with the same reference numerals in FIGS. 1, 2 and 3. The incandescent filament 2 is aligned axially in the lamp vessel 7 such that its first end 23 faces the sealed end 71 and the base 8 and, furthermore, it is partially surrounded by an anti-dazzle device 9. The two incandescent filaments 2, 6 are supported and provided with electric energy by three current supply wires 91, 92, 93 that are led out through the sealed end 71 of the lamp vessel 7 and are respectively connected to one of the three electric terminals 94 of the lamp 5. The first outgoing filament section 21 of the incandescent filament 2, which is sheathed by the molybdenum tube 25, is welded to the current supply wire 91, and the second outgoing filament section 22 of the incandescent filament 2, which is sheathed by the molybdenum tube 26, is welded to the anti-dazzle device 9.

The invention is not limited to the exemplary embodiments explained in more detail above. The minimum value D1 for the outside diameter of the first turn of the incandescent filament 2 can assume values in the range from 0.4 millimeters to 1.2 millimeters, and the maximum value D2 for the outside diameter of the last turn of the incandescent filament 2 can assume values in the range from 0.6 millimeters to 2.2 millimeters. Moreover, it is possible, for example, to reduce the thickness of the filament wire 200 and raise the number of turns of the incandescent filament 2 in order to adapt the incandescent filament 2 to a higher vehicle network voltage than 12 volts, for example to a nominal vehicle network voltage of 24 volts. The invention is particularly suitable for H1 lamps, H7 lamps and H4 lamps. In order to increase the luminance at the light/dark boundary even further, the incandescent filament 2 can additionally have a pitch at its first end 23 that is reduced by comparison with that at the second end 24.

1. An electric incandescent lamp having at least one incandescent filament which is arranged inside a transparent lamp vessel and whose outside diameter increases continuously, starting from a minimum value at a first incandescent filament end, up to a maximum value at the second incandescent filament end, wherein the following condition is fulfilled:
$$\frac{D2 - D1}{2 \cdot L} \leq 0.0875$$
for the minimum value D1 and the maximum value D2 as well as for the length L of the at least one incandescent filament (2).

2. The electric incandescent lamp as claimed in claim 1, wherein one end of the lamp vessel is provided with a base, and said first incandescent filament end of the at least one incandescent filament faces said end of the lamp vessel that is provided with the base.

3. The electric incandescent lamp as claimed in claim 1, wherein the filament axis of said at least one incandescent filament is arranged parallel to the longitudinal extent of the lamp vessel or of the incandescent lamp.

4. A halogen incandescent lamp for vehicle headlights as claimed in claim 1.

5. A halogen incandescent lamp for vehicle headlights as claimed in claim 2.
